(19) United States
(12) Patent Application Publication
(10) Pub. No.: US 2004/0250912 A1
(43) Pub. Date: Dec. 16, 2004

(54) Wood profile and method for the production of the same

(76) Inventors: Peer Haller, Dresden (DE); Joerg Wehsener, Dresden (DE); Sonja Ziegler, Neudrossenfeld (DE)

Correspondence Address: Karl Hormann, P O Box 381516, Cambridge, MA, 02238-1516, US

(21) Appl. No.: 10/479,439

(22) PCT Filed: May 30, 2002
(86) PCT No.: PCT/DE02/02030

(30) Foreign Application Priority Data
May 30, 2001 (DE) 101 27 400.9

(51) Int. Cl. B27F 5/00

(52) U.S. Cl. 144/345

(57) ABSTRACT

The invention relates to a profile of round or sawn timber and a method for producing the same. Such profiles can be produced essentially from all types of wood of coniferous trees and wood of deciduous trees, including low-grade wood of coniferous trees (secondary products, weak round timber), which can be obtained in large quantities in forestry. The inventive profile has a considerably larger load capacity compared to cross-sections of solid wood, for the same volume of wood. The wood as raw material is used to the maximum.

The invention relates to a profile made of round or cut timber and to a method of its manufacture. In principle, the profiles may be made from any soft timber or hard timber (i.e. timber from coniferous and foliate trees—translator's note), among these low value soft timber (sapwood, weak round timber, knotty timbers) which are abundant in forestry.

For material-saving constructions, timber profiles are of low utility. Economic cross-sectional forms of significant carrying strength such as box profiles and I-shaped profiles are being used only in cases of high stress. Their manual fabrication is complex and is carried out by joining individual profiles of sawed timber or wood-based materials. Aside from glue, pin-shaped fasteners are frequently applied which lead to losses in structural rigidity, however. The use of bent profiles is usually restricted to round solid cross-sections. Since the use of de-barked trunk timbers is limited, machining and severing techniques are used for fabricating round wooden elements and hollow profiles. In the case of larger dimensions, bent cross-sectional shapes or hollow structures can at present only be fabricated at high cost by uniting of squared timbers.

Wood is a porous non-uniform material. It contains differently disposed cavities. These cavities are contained within the cells or are enclosed by cells. The lignin is plasticized by way of hygro-thermal action so that the walls of the cells are folded under pressure and the cavities are reduced.

The thermal change of wood components commences at temperatures below 100° C. and, beginning at 200° C., leads to the decomposition of hemicellulose. The heat-induced changes in phase (solid/liquid) in the individual components take place at different temperatures.

A method and an apparatus for compressing wood are known from (German) patent specification No. 601,162, whereby the timber is multilaterally compressed in a direction substantially normal to the fiber direction and is optionally subjected, in its compressed state, to a heat treatment or impregnation. Compression takes place by two-fold successive pressing so that the resulting compression is more uniform and complete than in prior known systems.

For the fabrication of wooden shaped parts, it is known from (German) patent specification 636,413 to compress synthetic resin saturated pieces of wood in the fiber direction within a heated mold.

To compress wood in the longitudinal direction of the fibers and to bend it around an axis disposed approximately vertically of the longitudinal fiber direction has been known for a long time, e.g. DE 318 197. In furniture industry, this process serves to increase the bendability of glued veneers for furniture panels and the like. With buckled bent timber from healthy hard timber, deformation values of a thickness to bending radius ratio t/r are possible up to 0.25.

Special compression machines, bending machines or rollers make possible the forming of veneers and plywood with very thin peeled veneers of soft woods over their surface and with double bends.

Moreover, a method is known of compressing layers to solid pressed wood—known as Lignostone®—by application of external pressure. With this product, maximum densities of 1,460 kg/m³ are attained. By increasing the bulk density, the mechanical properties in respect of hardness and strength are substantially improved. Pressed red beech veneers have tensile and bending strengths similar to steel.

Synthetic resin timbers and insulating solid timbers in accordance with DIN 7707 are prior art as well.

By varying the process in respect of compacting pressure, moisture of the timber, temperature and time, the mechanical properties, the dimensional stability and the durability as well as resistance against animal or vegetable parasites may be selectively changed or improved.

From DE 197 43 703 A1 a method is known of forming timber by hydrostatic pressure. In accordance with the method, primary wood is converted to a softened state by a water content of 10 to 80% by weight and for forming, the softened timber is subjected to the hydrostatic pressure of a pressure fluid and the pressed state of the timber is fixed by a treatment. The result, without using a mold, is compressed timber of an improved physical appearance and improved material characteristics compared to the primary timber.

Moreover, a great many plastizing methods are known (e.g. treatment with hot steam, water vapor treatment) which increase the ductility and which include water-repellant impregnants which, by reducing the moisture absorption by hydrophobing the inherently hydrophilic surface of the timbers, lastingly maintain the effect of the improvement. An example of this kind is the solid pressed wood known by the name of Calignum®, which prior to compression is selectively impregnated and which, therefore, does not swell when stored under humid conditions, and which is thus dimensionally stable.

It has been found that temperatures between 100° C. and 200° C. and compaction pressures from 5 to 30 MPa are generally suitable for the pressing operation but that they affect the form stability differently. Care must be taken that the moisture contained in the timber must be limited, the positive effect notwithstanding, in order to minimize the risk of a steam explosion and the destruction of the cell structure resulting therefrom. The compression of timber fresh from the forest thus requires a concerted heating and drying phase.

It is also known that the so-called “memory effect” of pressed wood, to return to its shape under humid conditions, may be eliminated by a selective process control, such as steam treatment and reverse cooling.

A method of fabricating pressed timber from round wood is known from WO 94/20273. In accordance therewith, the round wood is pressed transversely to the fiber direction into squared timber in a shaping device and is thereafter heated to a temperature above 100° C. for rendering the wood plasticizable. Thereafter, it is cooled to a temperature below the plasticizing temperature so that the imparted shape is retained. The squared timbers thus obtained may be adhesively laminated to plywood or panels. The method yields components of a resistant and hard wood.

It is an object of the invention to fabricate wood profiles by deformation of wood without destruction of the wood structure.

In accordance with the inventioon, the object is accomplished by the profile being bent from a wood panel, the bends extending about one or more axes and the projection of the axes onto the panel essentially coinciding with the direction of the fibers thereof. In accordance with the invention such a profile is fabricated by the timbers being placed adjacent each other and connected to a panel, by compressing at least one width portion of the panel over the entire length of the panel and transversely of the wood fibers, and by deforming the panel by bending at least a portion of the compressed width portion to a profile.

Advantageous variants of the profile and method are the subject of dependent sub-claims.

Compared to solid wood cross-sections, the profiles, at an identical wood volume, posses a significantly higher load capacity. The raw material, timber, is used to a maximum.

The panel may be compiled from boards or construction timbers which are connected to each other by their narrow sides. For particularly high demands of strength in wood construction, the boards or construction timbers may also be connected to each other by their broad sides. In the examples it will be shown how for this purpose, and with the intention of improving the utilization of the timber, the round timbers are compressed unilaterally or bilaterally and how parts of the timbers may be connected into a particularly durable panel.

As shown in greater detail in the sub-claims, examples and figures, open, closed, wave-like profiles or profiles of curved surface configuration may be fabricated. Of course, the structural multiplicity of the shape may be further increased by combining the profiles with each other or with non-deformed timbers.

In a preferred embodiment, a board or panel may be additionally compressed in the direction of its major surface for increasing its density and hardness, as is well-known.

The maximum possible bending radius for the shaping operation is primarily dependent upon the degree of compression and upon the thickness of the panel.

In preparation of the compression and/or bending the timbers or panels are rendered bendable or plasticized by known thermo-hygric agents and/or chemicals.

Impregnation of the timber with fungicides, flame retardants or resins may in a simple manner incorporated in the technological process.

A further advantageous embodiment results from applying, following the shaping operation, a veneer or technical textile to one or both sides of the profile. In this manner, the product may be optically upgraded, protected or reinforced.

The invention will hereafter be described in greater detail with reference to embodiments. In the drawings:

FIG. 1-4 depict various embodiments in accordance with the invention for exemplification;

FIG. 3-7 depict various profiles in accordance with the invention; and

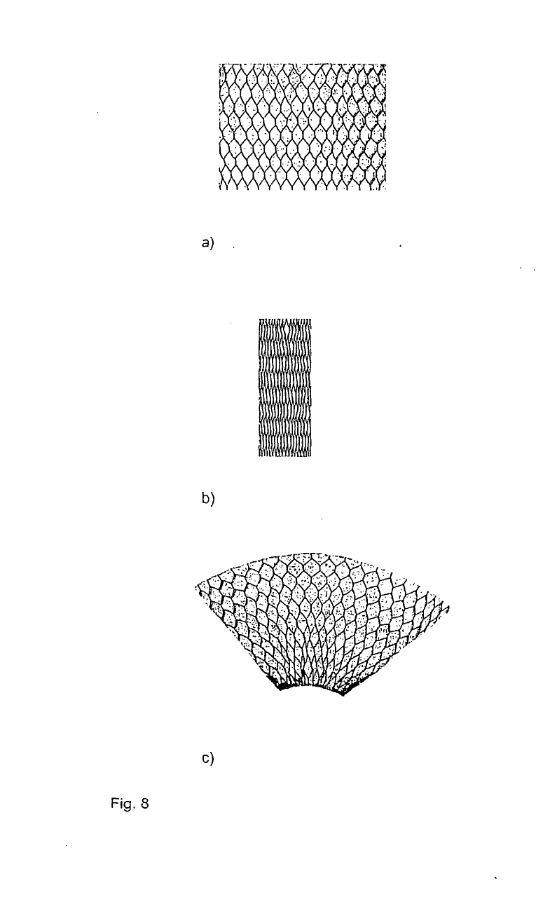

FIG. 8 is a schematic view for exemplifying the change in cell geometry.

In FIG. 1, the method in accordance with the invention in steps. Steps a) through c) each show a cross-section: a) depicts the cross-section of a construction timber; b) depicts the cross-section of a panel, and c) shows the cross-section of a profile. The longitudinal dimension of the construction timber, the panel and the profile each extend in the longitudinal direction of the fibers of the wood. In step b) several construction timbers are arranged as a panel. The two construction timbers shown in shading were previously, in step a) compressed in the direction of the arrow, i.e. transversely of the longitudinal direction of the fibers of the wood and parallel to the plane of the panel. For this purpose, the wood is first heated until a pressing temperature of 130-160° C. has been reached. This may be carried out by contact heating in a press or by microwave heating. Thereafter, the wood is compressed at pressures of 5 to 30 Mpa. The degree of compression of the wood compressed in a lateral direction may be freely selected between 1 and 3, depending upon the intended deformation. Following compression, the wood is maintained in its mold and is cooled to below 70° C. in order to reconvert the wooden components and connections to a rigid state. Advantageously, cooling will take place at the exterior of the shape imparting device while maintaining the achieved shape.

The compressed construction timbers in the panel are alternatingly arrayed with non-compressed construction timbers and they are glued together by their narrow sides. In corresponding with the combination of compressed and non-compressed semi-finished products, the panels may be custom-made as an intermediate product as regards the cross-sectional requirements in respect of the profile.

For further execution of the method, the panel is heated to a temperature of between 70 and 200° C. and its moisture content is raised to between 6% and fiber saturation and is than shaped as a U-profile in a shape imparting device. The shape is imparted by extending the compressed sections in the semi-finished goods, the outward ones being extended particularly strongly.

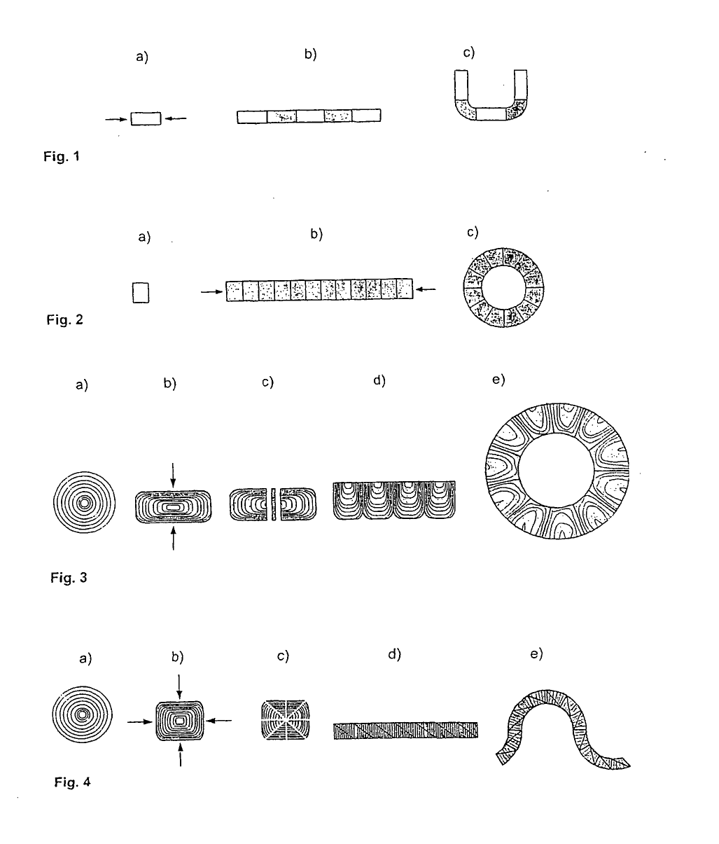

In the second embodiment shown in FIG. 2, the construction timbers are arranged and connected to each other by their broad sides. All construction timbers are compressed. In this embodimend, this has been realized by the panel being compressed in the shown direction of the arrow, i.e. parallel relative to the plate and transversely of the fiber direction. Such a panel is particularly suitable for fabricating a tube. The deformation may take place immediately following the compression of the panel, so that another heating of the wood may be avoided.

The embodiment of FIG. 3 proceeds on the bases of a debarked round wood a). Initially, in step b), the round wood is compressed transversely of the direction of fibers. After the compression, the semi-finished product is cut separated from the core c). The result is two semi-finished products. The compressed semi-finished products are now glued together d) form a panel such that as shown at the upper surface all semi-finished products are of the highest degree of compression, and of the lowest degree of compression at the lower surface. During shaping, the compression at the upper surface is substantially reversed whereas the lower surface experiences but a small change in density. Panels compressed in this manner can preferably be reshaped as columns.

The embodiment of FIG. 4 also proceeds on the basis of debarked round wood a). In step b) the round wood is compressed in two directions which are orthogonal with respect to each other, and transversely of the fiber direction. Thereafter, the compressed wood is divided into eight triangular parts by two center and two diagonal cuts. The parts are then, as may be seen at c), arranged as a panel. Care is taken to place the main directions of compression of the parts are disposed parallel to the plane of the panel. In this example, a wave-like profile is formed from the panel.

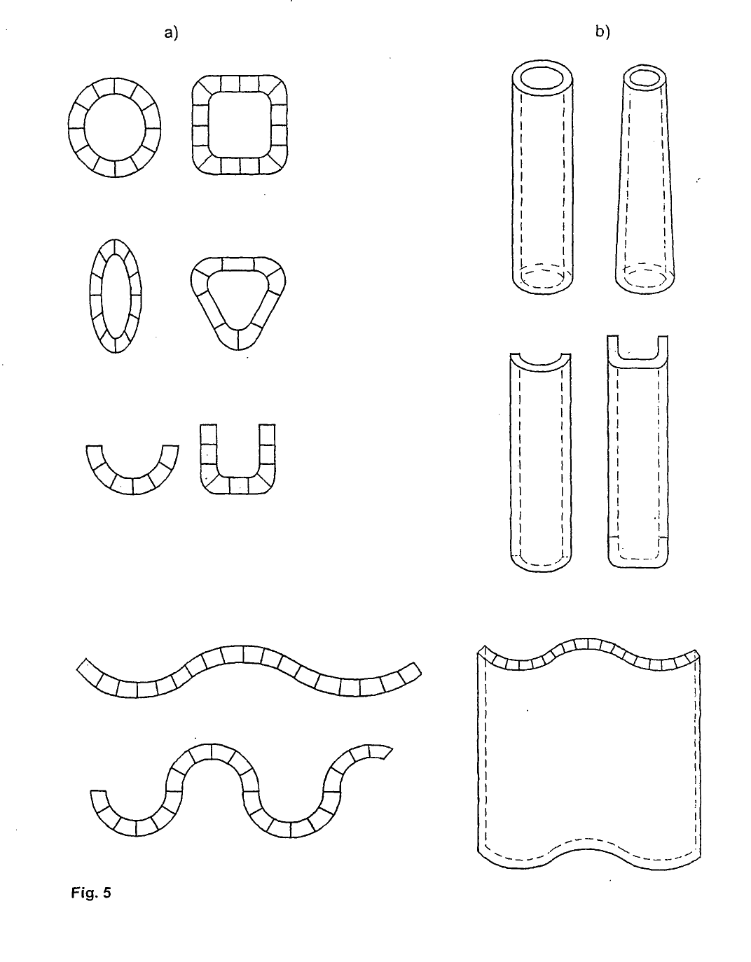

FIG. 5 depicts a number of possible profiles. It is possible to fabricate open or closed hollow profiles of oval or circular cross-section as well as of triangular or rectangular cross-sections with rounded corners. Wave-like profiles of small or large radius of curvature may also be fabricated. A conical profile is also shown. In that case the radius of curvature increases along the extent of the longitudinal axis. Beginning at upper cross-section of the smallest diameter, the cells disposed at the interior side are progressingly extended. A truncated cone fabricated according to this principle is shown in FIG. 6.

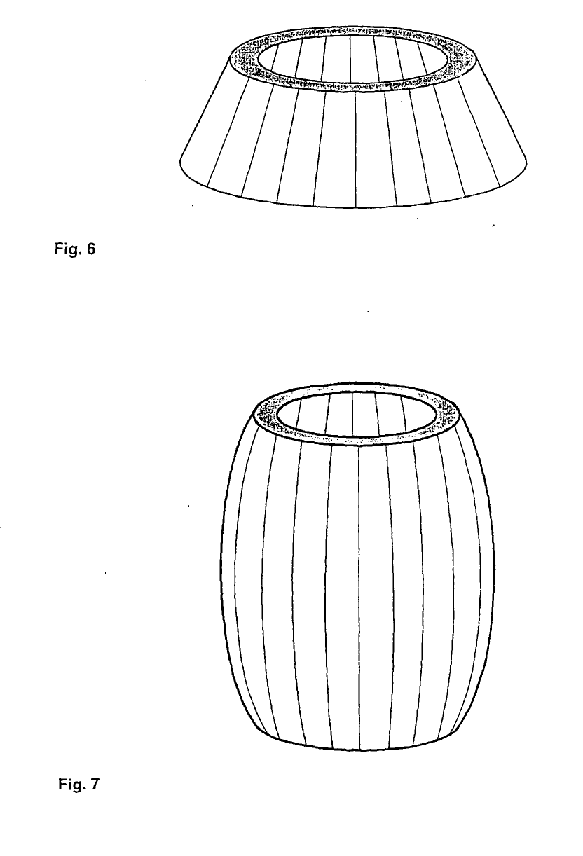

In FIG. 7, the radius of curvature also changes as a function of the axis of the profile. In the center the cells disposed at the interior side are extended more strongly than they are in the vicinity of the end surfaces. A barrel may be fabricated in this manner.

FIG. 8 contains images of schematically depicted cell structures of the wood. The partial image a) depicts the un-compressed cell structure. After compression, the cavities, as shown in the presentation of the partial image b), are significantly reduced. In this connection, the wood may be compressed to a degree of compression of 3. As shown in partial image c), when shaping for producing a cylindrical hollow profile, the upper area is stretched until the original cell structure has been attained. The lower area remains uncompressed.

1. A profile from round or cut timber, characterized by the fact that the profile is bent from a wooden panel, that the bends extend around one or more axes and that the projections of the axes onto the panel essentially coincide with the fiber direction thereof.

2. The profile from timber of claim 1, characterized by the fact that the wooden panel is assembled from round or cut timbers arranged approximately parallel to each other.

3. The profile from timber of claim 2, characterized by the fact that the wooden panel consists of boards or construction timbers the broad sides of which are connected to each other,

4. The profile from timber of claim 2, characterized by the fact that the wooden panel consists of boards or construction timbers the narrow sides of which are connected to each other.

5. The profile from timber of claim 1, characterized by the fact that the wooden panel consists of a board.

6. The profile of claim 1, characterized by the fact that in the profile at least some of the timbers are connected to each other by dovetailing.

7. The profile from timber of claim 1, characterized by the fact that at the outer surface thereof it is unilaterally open, e.g. as a profile of angular or U-shaped cross-section.

8. The profile from timber of claim 1, characterized by the fact that it is closed at the circumference of the outer surface, e.g. as a profile of circular, elliptical, triangular, square or rectangular cross-section.

9. The profile from timber of claim 1, characterized by the fact that it is provided with bends extending in alternating directions, e.g. a profile of wave-shaped cross-section.

10. The profile from timber of claim 1, characterized by the fact that along a bending axis the bending radii are of different sizes, e.g. a profile the outer surface of which parallel to the axis of the profile is bent conically, barrel-shaped or similarly.

11. The profile from timber of claim 1, characterized by the fact that the longitudinal axis of the profile and the direction of the fibers extend obliquely of each other.

12. A method of producing profiles from round or cut timber, characterized by the fact that the timbers are placed adjacent to each other and are connected to a panel, that at least one broad portion of the panel is compressed in the plane of the panel over the entire length of the panel and transversely of the timber fiber, and that the panel by bending of at least a part of the compressed broad portion is shaped into a profile.

13. The method of claim 12, characterized by the fact that the panel is formed from compressed and uncompressed round or cut timber.

14. The method of claim 12, characterized by the fact that the panel is additionally compressed in the direction of the plane of the panel.

15. The method of claim 12, characterized by the fact that round timbers are compressed in one direction, that they are divided in the direction of compression and of fibers and that the halves are arranged and connected in the panel such that the dividing surfaces of the round timber halves are positioned at a side of the panel.

16. The method of claim 12, characterized by the fact that round timbers are compressed in two direction disposed orthogonally of each other, that they are divided by cross and diagonal cuts into eight parts of triangular cross-section and that the parts are arranged and connected in the panel such that one of the main compression directions is positioned in the plane of the panel.

17. The method of claim 12, characterized by the fact that after shaping the profile is at one side or at two sides coated with a veneer or a technical textile.

18. The method of claim 12, characterized by the fact that the timbers or the panel are impregnated with fungicidal and/or fire retardent agents and/or with resins.

19. The method of claim 12, characterized by the fact that prior to compressing and/or bending the timber or the panel is made bendable or plasticized thermohygrically or with chemicals.

20. The method of claim 12, characterized by the fact that the shape of the profile is permanently fixed after shaping.
